(19) United States
(12) Patent Application Publication
(10) Pub. No.: US 2006/0293936 A1
(43) Pub. Date: Dec. 28, 2006

(54) Method and system for automatically transforming a provider offering into a customer specific service environment definition executable by resource management systems

(76) Inventors: Gerd Breiter, Wildberg (DE); Georg Bildhauer, Nufringen (DE); Harald Daur, Esslingen (DE); Georg Ochs, Moetzingen (DE); Andrea Schmidt, Boeblingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 10/562,504

(22) PCT Filed: May 13, 2004
(86) PCT No.: PCT/EP04/50787

§ 371 Date: Jul. 10, 2006

(30) Foreign Application Priority Data
Jun. 26, 2003 (EP) 03101904.5

(51) Int. Cl. G05B 19/418

(52) U.S. Cl. 705/8

(57) ABSTRACT

The idea of the present invention is to provide a method for automatically transforming a provider offering describing a customer specific service environment in business terms into a machine readable form which can be automatically processed by resource management systems. The input for the transformation is the provider's offering in business terms as well information from the resource catalog. The result of the transformation is a customer specific service environment topology that states all the necessary resource types, their configurations and their dependencies. Based on that customer specific service environment topology and information from the resource management catalog, a customer specific service environment definition (SED) is automatically generated which contains all the configuration information and definitions of the resource management actions in order to instantiate and drive the operation of the service environment. The SED can be deployed into a resource management system that automatically executes the resource management actions without the error prone configuration steps otherwise needed.

### FIELD OF THE INVENTION

The subject of present invention relates to outsourcing of IT business in general, and in particular how to set up an appropriate defined service environment at the service provider side which technically secures that the conditions as agreed in the respective outsourcing agreement between customer and service provider will be fulfilled.

### BACKGROUND OF THE INVENTION

In the traditional outsourcing business the customers who want to concentrate on their core business hand over their IT business or at least parts of it to service providers who run the IT business for several customers. For each outsourced IT business of a specific customer the service provider has to define a customer specific service environment. The term customer specific service environment as used in the present patent application defines all resources needed for a certain customer, how to manage those resources in order to fulfill the conditions of the outsourcing agreements, how to handle situations like resource shortages or resource over-provisioning, and the appropriate assigned resource management actions like configuring or installing of said resources. Each IT component within said customer specific service environment represents a so-called resource. For example a resource may be hardware (e.g. server), software (application programs), network with certain channel capabilities, disks etc. In normal situations a lot of resources are not used, however they cannot be provided to other customers. Therefore the idea came up to share the resources between the different customers in order to improve the utilization and decrease the costs. Autonomous resource control systems automatically monitor the utilization of the resources and dynamically allocate new resources or de-allocate resources if more or less capacity is needed.

Service providers also want to host different service environments running in the same infrastructure and sharing the resources in order to achieve the best utilization of the resources available and thus maximize their profit.

In order to achieve a greater profit service providers normally tend to overbook their resource infrastructure that means they accept agreements without being able to provide all resources needed in case of peak loads. Thus it is possible that resource conflicts occur so that not all agreements can be fulfilled simultaneously. In such situations the conflicts have to be resolved based on business aspects, i.e. which decision has the minimum negative effect on the provider's business. This has to be done either on a customer level to resolve conflicts between competing service environments of the same customer, or on service provider level to resolve conflicts between competing service environments of different customers. Again the result is a list of resource management actions like shutting down an operating system, assigning the machine to another customer and restarting this machine with the appropriate software.

In order to present a certain service to potential customers, the service provider describes a customer specific service environment in form of an offering. The term offering as used in the present patent application describes a customer specific service environment exclusively in business terms and does not contain any details on the real resources or its assigned resource management actions. The problem for the service provider is to map or transform this form of an offering to a customer specific service environment being executable by the resource management system.

The present patent application describes a method of doing such a transformation.

### STATE OF THE ART

In the State of the Art systems, the transformation of the offering is either a static lookup of the corresponding resource management actions or a manual time consuming creation of them. The first method is applicable for static environments, i.e. each customer gets exactly the same service environment. In case of parameterized offerings, the corresponding resource management actions have to be defined and or adopted manually which is a complex and therefore error prone process. Typically the resource management actions are described by documentation, if at all, which lists the operator's tasks to be done in order to create and operate the customer's service environment. Some steps of automation have already been achieved using installation and configuration programs and/or scripts. However that type of automation still requires some kind of manual processing, at least the selection and parameterization of these programs, and their execution at the requested point in time. Autonomous resource control systems require all kind of management actions in a machine-readable form with defined syntax and semantics. The system creates and operates the customer specific service environment according to defined rules and activities. The whole process of creation, operation and deletion of the customer specific service environment must be supported by providing appropriate machine readable task lists, rules for the dynamic allocation and de-allocation of resources, and the service environment specific inter-component messaging (events and subscriptions). All these information are generated by the method described in this invention.

### OBJECT OF THE INVENTION

Starting from this, the object of the present invention is to provide a method and system for automatically transforming a provider offering describing a defined service environment (customer specific service environment) in business terms into a machine-readable and executable form (customer specific service environment definitions) which can be automatically processed by resource management systems.

### BRIEF SUMMARY OF THE INVENTION

The idea of the present invention is to provide a method for automatically transforming a provider offering describing a customer specific service environment in business terms into a machine readable form which can be automatically processed by resource management systems.

The input for the transformation is the provider's offering in business terms as well as information from the resource catalog. The result of the transformation is a customer specific service environment topology that states all the necessary resource types, their configurations and their dependencies. Based on that customer specific service environment topology and information from the resource management catalog a customer specific service environment definition (SED) is automatically generated which contains all the configuration information and definitions of the resource management actions in order to instantiate and drive the operation of the service environment. The SED can be deployed into a resource management system that automatically executes the resource management actions without the error prone configuration steps otherwise needed.

### BRIEF DESCRIPTION OF THE SEVERAL VIEWS OF THE DRAWINGS

The above, as well as additional objectives, features and advantages of the present invention will be apparent in the following detailed written description.

The novel features of the invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a block chart of the inventive system for transforming a provider offering describing a customer specific service environment in business terms into a machine-readable and executable customer specific service environment definition,

FIGS. 2 A/B show a specific implementation of the Resource catalog which is preferably used by the present invention,

FIG. 3 shows detailed flow chart of the inventive transformation process for creating the customer specific service environment topology,

FIG. 4 shows an example of a customer specific service environment topology as a result of the inventive transformation process,

FIG. 5 shows an example of a more complicated structure of a customer specific service environment topology as a result of the inventive transformation process,

FIGS. 6 A/B show a preferred embodiment of the inventive compilation process, and

FIG. 7 shows a detailed flow chart of the overall inventive compilation process.

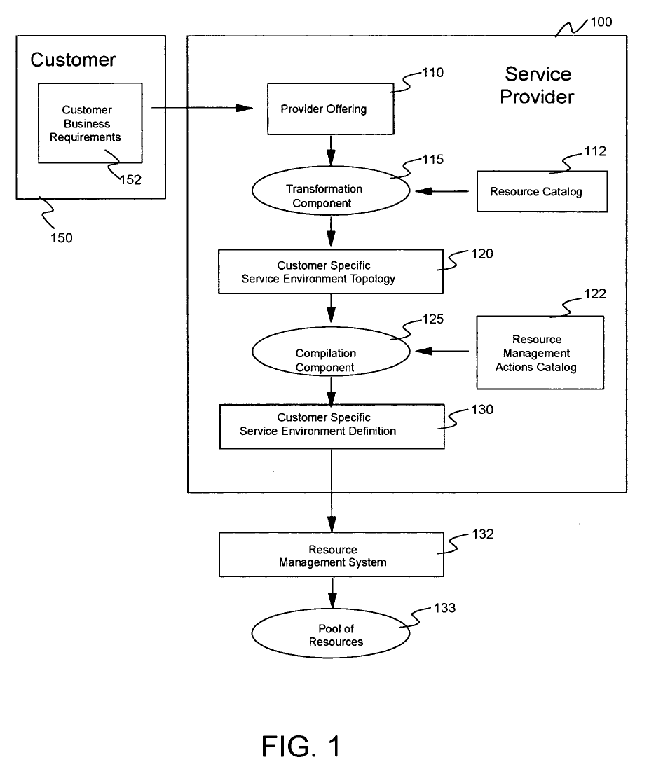

With reference to FIG. 1, there is depicted a block chart illustrating the inventive components for transforming an offering describing a customer specific service environment in business terms into a machine-readable and executable customer specific service environment definition which can be processed by a resource management system. The inventive components may be preferably implemented in a client-server architecture in which the customer uses a client system 150 with an operating system like Microsoft Windows, and Internet Browser like Netscape, and the service provider uses a server system 100 like IBM pseries with an operating system like IBM AIX, an application server like IBM WebSphere Application Server, and a Web server. The server of the service provider 100 has access to a pool of resources 133 like hardware, programs, networks, disks etc via a resource management system 132. The pool of resources may be owned and managed by the service provider himself or the service provider uses another service provider's pool of resources.

The customer preferably communicates with the service provider via communication protocol HTTP/TCPIP.

In the first step the service provider creates a certain offering in business terms and puts it on his server. The customer who has concluded a service agreement with the service provider can accept that offering. The conclusion of the service agreement as well as the acceptance of the offering can be executed via online communication between customer and service provider.

The inventive method can be briefly summarized as follows: The provider offering 110 and information from the Resource Catalog 112 are used as input for the Transformation component 115. The output of this Transformation component 115 is a customer specific service environment topology 120. This customer specific service environment topology 120 is used as input together with the resource management actions 122 from the resource management actions catalog for the Compilation component 125. The final output of the Compilation component is a customer specific service environment definition 130 which includes a set of all resource management actions which can be deployed into a resource management system 132 (not part of the invention) which automatically executes the resource management actions.

The resource catalog 112 itself contains individual descriptions for all resource types which are available in the Service Provider's infrastructure. There are base resource types as well as complex aggregated resource types described in the catalog.

Base resource types contain references to certain programs (interpretable tasks) which are able to execute the resource management actions (e.g. create/delete) for these resources, interface information for said programs, and additional data necessary to manage the resources by a resource management system.

For example the base resource type “server system” is described by a reference to its resource management actions. These resource management actions are interpretable tasks such as creation and deletion of a resource in machine-readable form. For example such a action may be described by an URL which references a Web Service. The base resource type definitions and the corresponding management actions may be provided by the resource manufacturer or the service provider itself.

Beside these base resource types, the resource catalog contains categorized aggregated resource types, which provide several abstraction levels within the resource catalog. Again, these aggregated resource types may be provided by certain resource manufactures or created by the service provider according to its needs.

An aggregated resource type contains references to one or more other resource types with certain parameters for them or a certain combination of them or both. E.g. an aggregated resource type ‘HIGH-SECURE FIREWALL’ may reference to the ‘STANDARD FIREWALL’ with configuration parameter to only open port 80, where ‘MEDIUM-SECURE FIREWALL’ references the same ‘STANDARD FIREWALL’ but with configuration parameters to open port 80 AND 1024. An example where multiple resource types are referenced is the aggregated resource type ‘SECURE WEBSERVER’ which may reference a ‘WEBSERVER’ resource type and a ‘FIREWALL’ resource type with their appropriate parameters.

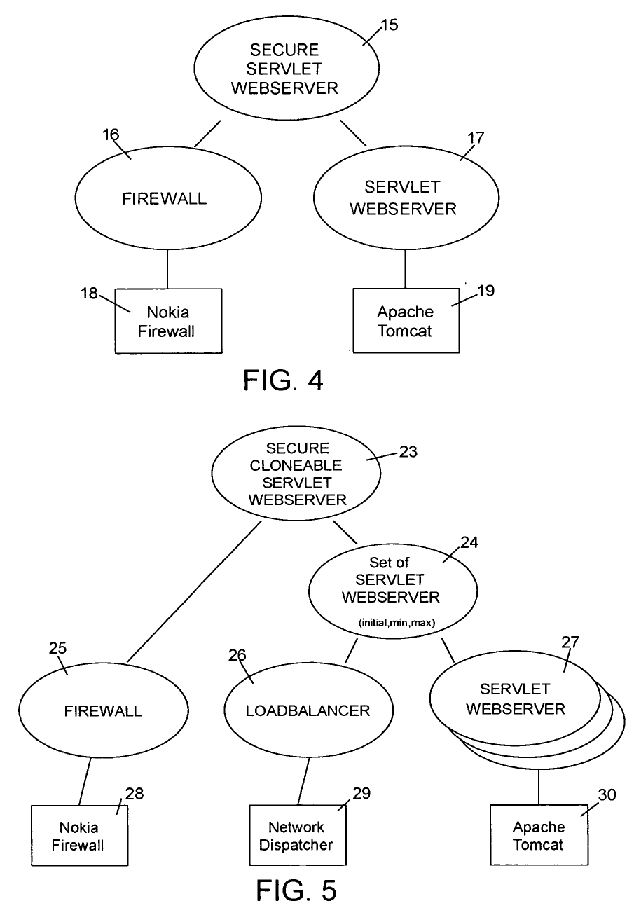

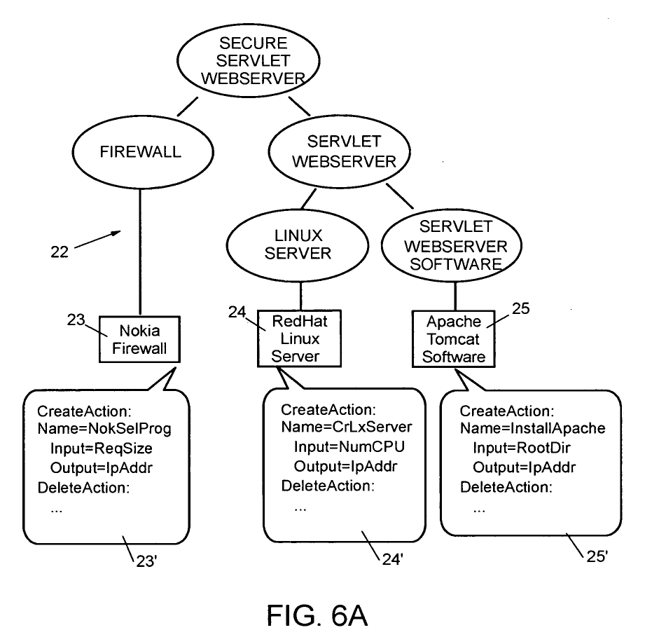

FIG. 4 and FIG. 5 show examples of the categorization of resources. The categories are used to build higher abstracted resource types up to the offering level. Technical details such as base resource types and their configuration parameters are hidden on the higher abstraction levels and are represented by categorization information (such as ‘SECURE’ or ‘UNSECURE’).

The highest aggregation levels are used for the service provider's offering as it describes a customer specific service environment in the terms as used for the categorization. The generation of this offering related resource types may be supported by certain tooling.

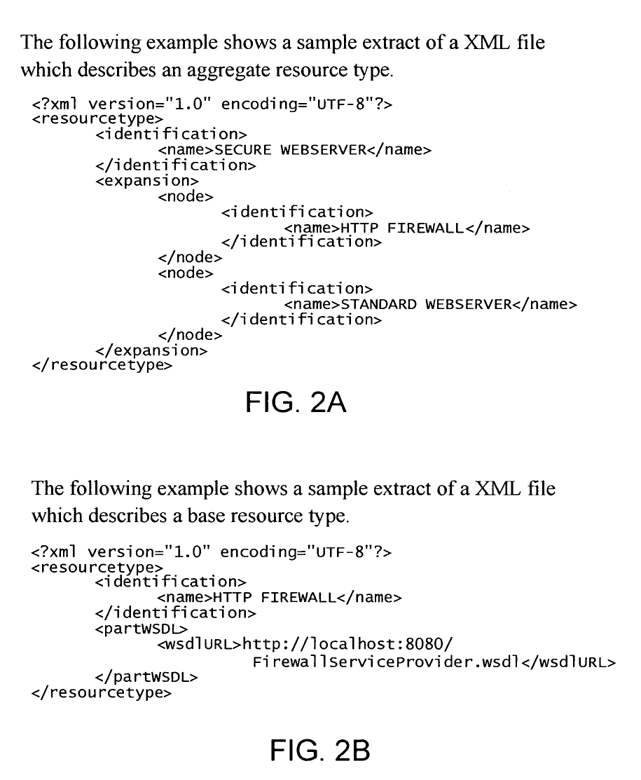

The resource catalog may be implemented as a certain table in a database or even just as plain XML file or files. FIG. 2 A shows a sample extract of such a XML file which defines an aggregated resource type “SECURE WEBSERVER”, which consists of a HTTP FIREWALL and a STANDARD WEBSERVER. FIG. 2 B shows a sample extract of such a XML file which describes a base resource type “HTTP FIREWALL”.

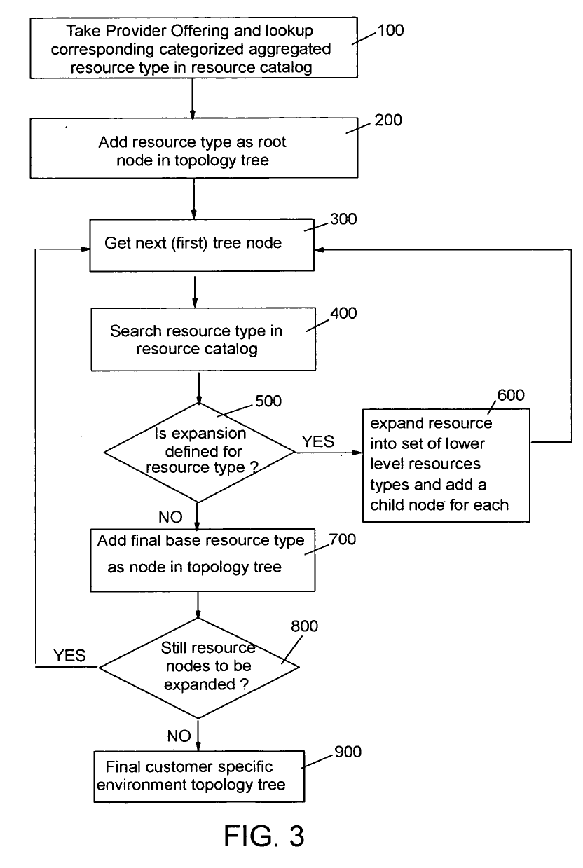

The inventive transformation process is carried out by the transformation component which is described with reference to FIG. 3.

The transformation method is based on the categorization and aggregation of the provider's resource types as stored in the resource catalog. The method itself is independent of the specific assignment of resource types into categories—it is only important to have a categorization of resource types.

The categorization of the highest aggregation, i.e. the highest abstraction level, is used in the provider offering, such as a “SECURE WEBSERVER” offering. Category “SECURE” means in this example, that a firewall with special attributes and configurations is part of the offered service environment.

The inventive method takes a service provider offering as input and builds a resource type topology tree 100-200. Root of the topology tree is the offering itself.

As the offering references an aggregated resource type with certain categorization information, the method looks up this resource type in the resource catalog 400. The entry matching the search criteria typically is an aggregated resource type itself. Again, the aggregated resource type is expanded by the categorization information found in the resource catalog which typically results in one or more referenced resource types 500-600. I.e. the starting node of the service environment gets expanded in one or more expanded child nodes 600.

The method works recursively, which means for each expanded child node in the topology tree, it searches for the categorization information in the resource catalog and expands it, if found and so on. The recursion ends, if a base resource type is referenced which is not further expandable. In this case the node is a leaf node in the tree 700-800. It represents a specific base resource which has to be managed in the customer specific service environment implementing the offering.

After the transformation process has finished, the customer specific service environment topology tree has been build 900. Each leaf in the tree represents a certain base resource type. Up to this step in the processing no individual resources have been selected, only the resource type of the required resources has been determined. Furthermore, the topology of the tree also represents the relations between later chosen resources of certain type.

With reference to FIG. 4, an example of simple customer specific service environment topology tree created by the transformation component is described. A simple provider offering would be “SECURE SERVLET WEBSERVER15”. The offering describes the service environment exclusively in business terms without any references to specific resources. For the example, the following categories are defined in the resource catalog:

SECURE SERVLET WEBSERVER 15—expands to FIREWALL 16 and SERVLET WEBSERVER 17,

FIREWALL 16—references to NOKIA firewall with port 80 only released 18,

SERVLET WEBSERVER—references to Apache Tomcat WebServer 19

Using these definitions, the method looks up “SECURE SERVLET WEBSERVER 15” in the resource catalog, which will expand into a NOKIA firewall 18 and an Apache Tomcat Webserver base resource type 19.

With reference to FIG. 5, another more complex resource type topology is described.

A more complex example will use parameterized attributes to control the layout of the topology tree. For example the generation of resource clusters is handled using the parameterized “SET OF . . . ” attribute. The parameters for that attribute are the initial size, the minimum and maximum size of the set.

In this example the service provider offering is “SECURE CLONEABLE SERVLET WEBSERVER 23”.

The following categories are defined in the resource catalog:

SECURE CLONEABLE SERVLET WEBSERVER 23—expands to FIREWALL 25 and SET OF SERVLET WEBSERVER 24,

FIREWALL 25—references to NOKIA firewall with port 80 only released 28,

SET OF SERVLET WEBSERVER 24 expands to LOADBALANCER 26 and multiple (initial, min, max) SERVLET WEBSERVER 27 SERVLET WEBSERVER 27 references to Apache Tomcat WebServer 30 LOADBALANCER 26 references to IBM WebSphere Edge Server Network Dispatcher 29

Using these definitions the transformation component will create the customer specific service environment topology tree as shown. The number of resources for the “SET OF . . . ” is specified as parameter in the provider offering and stored in the topology tree as node attributes.

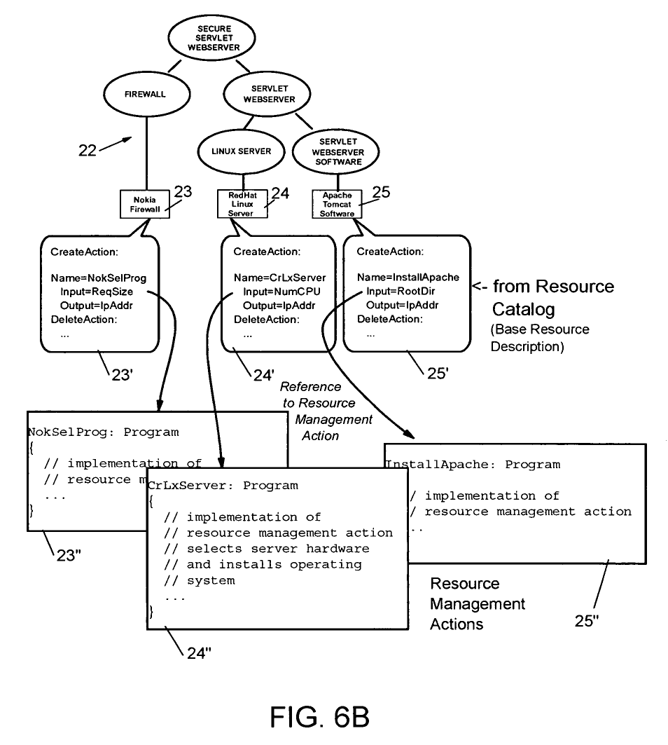

With reference to FIGS. 6 A/B, the basic functionality of the compilation process is described.

In order to instantiate and operate the customer specific service environment, certain tasks have to be completed. According to the customer specific service environment topology tree (22; see FIG. 6A) certain resources types 23-25 have to be selected and prepared in order to participate in the required service environment. During operation of that service environment certain measurements have to be taken, such as monitoring the response time of a user request to the web server. These measurements must be compared to limits as negotiated with the customer of the services environment. If the measured values exceed the limits, additional resources must be added to the services environment.

The whole creation and operation of the customer specific service environment can be done by an autonomous resource control system which is not part of that invention. In order to meet the customer specific definitions, the resource control system must be configured with customer specific definitions, which are the resource management actions for the customer specific service environment.

These resource management actions which are provided by a resource management actions catalog are a collection of items of following types:

interpretable tasks 23′-25′ to create and operate the service environment. These tasks may be references to resource specific installation and/or configuration programs 23″-25″ (see FIG. 6 B) or may be just described by the URL pointing to a web service.

Finally as described in the method below, these individual tasks for each resource are combined into a customer specific service environment task. To be machine readable, that composite task may be described using workflow technology, with all the resource specific sub-tasks which are individual activities in the workflow. The workflows itself may be described using e.g. a XML file according to the BPEL (Business Process Execution Language). This workflow description can be deployed into the workflow engine of the resource control system and executed as needed,

decision logic which can be implemented in the form of rules deployed into the rules engine of the resource control system. For example there may be rules for modeling the service provider business model, i.e. rules defining which customer out of the set of supported customers is the most critical in terms of business value, as this customer will be preferred in case of resource shortage. Another example are rules which define certain limits, and the actions to be taken in case the limits are missed. If these rules are deployed into the rules engine of the resource management system can e.g. autonomously react on certain situations and trigger the appropriate actions such as adding or removing resources to or from the customer's specific service environment,

events and subscriptions for events in order to enable communication between the participating resource management actions. This communication is necessary to e.g. propagate any state changes on the resources to the resource control system, so it can act as required. These events are the base for the situation detection and rules evaluation as described above.

The method as outlined in the following section has to generate all the above described resource management actions for a customer specific service environment. All these actions are in a machine-readable form, depending on the specific resource management system. Typically the actions are defined in some form of XML data like the BPEL workflow specification mentioned above. The set of all resource management actions is named SED, Service Environment Definition, in the method below, as this set defines the content and behavior of a specific service environment.

The compilation component requires following input:

a description of the service environment resource topology 22, e.g. in form of a directed a-cyclic tree. Each node 23-25 of the tree describes a resource type of the service environment. This information has been generated by the translation component as described earlier,

a set of simple resource management actions 23′-25′ each describing how to manage a single resource type by the resource control system.

For example the resource management actions action may be described by a URL pointing to a web service with the corresponding web service description in form of a WSDL. Using these formal descriptions, the method can introspect it and gather all required information about the actions.

Depending on the node type 22-25 certain actions are required. E.g. for leaf nodes in the tree 22-25 which represent base resources, management actions such as create and delete are mandatory 23′-25′. Those resource management actions will implement and/or reference to the appropriate installation and/or configuration program of the specific resource type. For intermediate tree nodes (aggregated resource types) like those defining sets of resources, the rules must be provided which define under which circumstances elements of the set are added or removed.

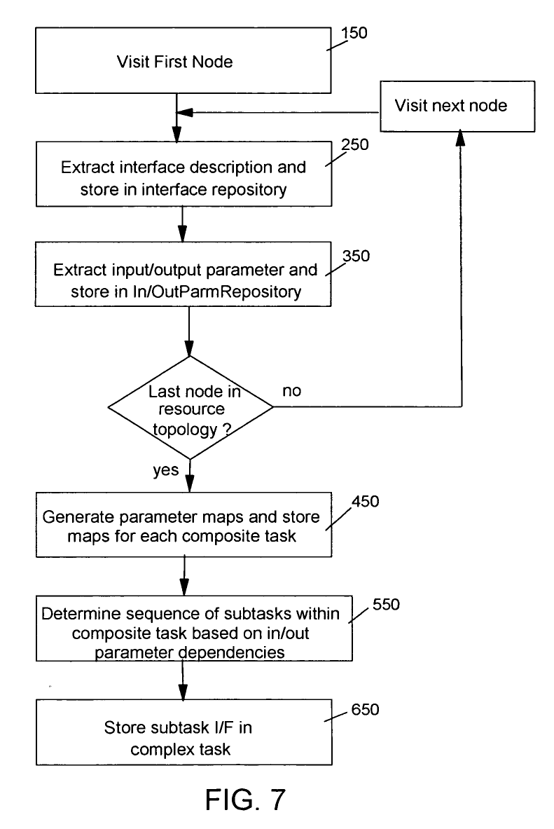

With reference to FIG. 7, the compilation method works as following:

Each node in the customer specific service environment topology is a resource type described by its resource management action. The method traverses the customer specific service environment resource topology 150 and combines the simple resource management action tasks of each node into several coherent tasks, e.g. a create task and a delete task 650. The description of these combined tasks is part of the SED (Service Environment Definition) which is the output of the compilation step. In addition the decision logic and the events and event subscriptions are combined and described in the SED.

The resource management actions provide common interfaces 250 that can be used to extract the description and interfaces of the tasks which are later used at runtime for management of the resources in the resource management system. The method scripts these simple tasks of the resource management actions to form a complex composite task that can be interpreted and executed at runtime in the resource control system. The input and output parameters 350 of adjacent subtasks have to be mapped using parameter name resolution 450. The sequence of the tasks in the result task is determined by the parameter maps, i.e. a subtask which requires a certain parameter P as input, must be sequenced after the subtask which provides this parameter P as output 550. Some kind of aliasing may be used to solve the parameter resolution by name. For example a load balancer resources requires the Apache server IP address as an input. Therefore the Apache servers have to be ‘created’ first to get these IP addresses and pass them to the load balancer create task.

An example for the scripting mechanism is workflow. Each resource management action provides a WSDL description of the implemented task, e.g. a create task and a delete task. These tasks which are also known as activities are combined into a complex workflow, e.g. a workflow to create a service environment. The input and output parameters of adjacent activities—which are SOAP messages—are mapped to each other using the message parameter names as described in the WSDL. The defined maps are part of the workflow. The output of the method is a complex workflow composed of a sequence of activities, the WSDL of each activity referring to the implementation and the parameter maps. This workflow can be used e.g. to create the whole service environment.

For service environments with variable sets of resources such as described in the FIG. 5, the compilation step will generate certain additional tasks to increase or decrease the number of members in such a group. E.g. the example of FIG. 5 uses a ‘SET OF SERVLET WEBSERVER’, the creation task will honor the given attribute for ‘initial’ number of elements. In addition the compilation will assemble the tasks for adding and removing a member to or from the group.

These additional tasks are executed by the resource control system if the given decision logic evaluates to request additional resources or release unused resources.

1. A method for automatically transforming a provider offering describing a customer specific service environment in business terms into a form which is automatically executable by a resource management system, the method comprises the steps of:
receiving a description of a provider offering in business terms without any references to specific resources;
providing access to a resource catalog containing descriptions of all available resource types including information about dependencies of said resource types belonging to said customer specific service environment as well as reference information to execute resource management actions for said resource types;
mapping said description of said provider offering with said resource type information contained in said resource catalog and generating a customer specific service environment topology tree comprising the steps of:
using said provider offering as root node of a customer specific service environment topology tree to be generated;
adding identified resource types as nodes in said topology tree which are mapping with said provider offering;
adding child nodes to said identified nodes when said identified resource types (aggregated resource types) map into a set of lower level resource types (child resources);
repeating the previous steps until said resource types cannot be mapped into set of lower resource types (base resource types;
providing access to a resource management action catalog containing resource management actions each describing how to manage a single resource type by a resource control system;
traversing said customer specific service environment topology tree, wherein each node in said customer specific service environment topology tree represents a resource type;
extracting from said resource management action catalog all resource management actions of said resource types identified in said customer specific service environment resource topology tree;
sequencing said extracted resource management actions according to requirements of said defined customer specific service environment; and
compiling said sequenced management actions into a machine readable form executable by said resource management system.

2. A method according to claim 1, wherein said resource management actions includes the operations creation, management and/or deletion of said resource types.

3. A method according to claim 1, wherein said sequence is defined by input and out parameter of said resource management actions.

4. A method according to claim 1, wherein said sequence is implemented as workflow executable by said resource management system.

5. A method according to claim 1, wherein said resource management actions are used to define a decision logic in form of rules to control the execution of said resource management actions.

6. A method according to claim 5, wherein said defined work flow process or said decision logic is implemented in a form of XML data.

7. A method according to 1, wherein said reference information includes a URL pointing to a Web Service with the corresponding Web Service description for execution of said resource management actions.

8. A system for transforming a provider offering describing a customer specific service environment in business terms into a form executable by a resource management system, comprising:
a transformation component for generating a customer specific service environment topology tree by:
receiving a description of a provider offering in business terms without any references to specific resources;
providing access to a resource catalog containing descriptions of all available resource types including information about dependencies of said resource types belonging to said customer specific service environment as well as reference information to execute resource management actions for said resource types;
mapping said description of said provider offering with said resource type information contained in said resource catalog and generating a customer specific service environment topology tree by:
using said provider offering as root node of a customer specific service environment topology tree to be generated;
adding identified resource types as nodes in said topology tree which are mapping with said provider offering;
adding child nodes to said identified nodes when said identified resource types (aggregated resource types) map into a set of lower level resource types (child resources); and
repeating the previous steps until said resource types cannot be mapped into set of lower resource types (base resource types);
a compilation component for generating a customer specific service environment definition by:
providing access to a resource management action catalog containing resource management actions each describing how to manage a single resource type by a resource control system;
traversing said customer specific service environment topology tree, wherein each node in said customer specific service environment topology tree represents a resource;
extracting from said resource management action catalog resource management actions of said resource types identified in said customer specific service environment resource topology tree;
sequencing said extracted resource management actions according to requirements of said defined customer specific service environment; and
compiling said sequenced resource management actions into a machine readable form executable by said resource management system.

9. A system according to claim 8, wherein said resource catalog contains categorized aggregated resource types which contain references to one or more other resources types with other parameters for them or a certain combination of them or both.

10. A system according to claim 8, wherein said provider offering forms the highest aggregation level of aggregated resource types and the base resources form the lowest not further expandable level in said resource catalog, wherein only said base resource types contain reference information to execute resource management actions for said resource types.

11. A system according to claim 8, wherein said resource catalog may be implemented in a form of a table stored in a database, or XML file stored in a file system.

12. A system according to claim 8, wherein said resource management actions includes creation, management, and deletion of said resource types.

13. A system according to claim 8, wherein each resource management action is defined by the name of the resource type, its task and its specific input and output parameter.

14. A system according to claim 8, wherein the result of said compilation component is a machine-readable description of sequenced resource management actions as well as decision logic for operating said customer specific service environment.

15. A computer program product stored in the internal memory of a digital computer, containing parts of software code to execute the method in accordance with claim 1 if the product is run on the computer.

16-20. (canceled)
